(19) United States
(12) Patent Application Publication
(10) Pub. No.: US 2009/0254707 A1
(43) Pub. Date: Oct. 8, 2009

(54) Partial Content Caching

(75) Inventor: Kent Alstad, Sechelt (CA)

Correspondence Address: RAUBVOGEL LAW OFFICE, 820 LAKEVIEW WAY, REDWOOD CITY, CA, 94062, US

(73) Assignee: STRANGELOOP NETWORKS INC., Vancouver (CA)

(21) Appl. No.: 12/187,233

(22) Filed: Aug. 6, 2008

Related U.S. Application Data
(60) Provisional application No. 61/043,165, filed on Apr. 8, 2008.

(51) Int. Cl. G06F 15/16; G06F 12/08

(52) U.S. Cl. 711/118; 709/203; 711/E12.017

(57) ABSTRACT

A network device, known as an appliance, is located in the data path between a client and a server. The appliance includes a cache that is used to cache static and near-static cacheable content items. When a request is received, the appliance determines whether any portion of the requested data is available in its cache; if so, that portion can be serviced by the appliance. If any portion of the requested content is dynamic and cannot be serviced by the cache, the dynamic portion is generated by the appliance or obtained from another source such as an application server. The appliance integrates the content retrieved from the cache, the dynamically generated content, and the content received from other sources to generate a response to the original content request. The present invention thus implements partial content caching for content that has a cached portion and a portion to be dynamically generated.

### CROSS-REFERENCE TO RELATED APPLICATIONS

The present application claims priority from U.S. Provisional Application Ser. No. 61/043,165 for “Partial Content Caching,” (Atty. Docket No. STR010-PROV), filed Apr. 8, 2008, the disclosure of which is incorporated herein by reference.

The present application contains subject matter that may be related to U.S. patent application Ser. No. 11/359,637 for “Storing and Retrieving User Context Data,” (Atty. Docket No. STR10830), filed Feb. 21, 2006, the disclosure of which is incorporated herein by reference.

The present application contains subject matter that may be related to U.S. patent application Ser. No. 11/623,028 for “Asynchronous Context Data Messaging,” (Atty. Docket No. STR12123), filed Jan. 12, 2007, the disclosure of which is incorporated herein by reference.

The present application contains subject matter that may be related to U.S. patent application Ser. No. 12/023,964 for “In-Line Network Device for Storing Application-Layer Data, Processing Instructions, and/or Rule Sets,” (Atty. Docket No. STR009), filed Jan. 31, 2008, the disclosure of which is incorporated herein by reference.

### BACKGROUND OF THE INVENTION

1. Field of the Invention

The invention generally relates to servicing requests over a network such as the Internet, and, more specifically, to the use of an in-line network device for caching static and near-static cacheable pages, documents, or other items of content.

2. Description of Background Art

It is well known to configure a client/ server architecture in which one or more servers respond to requests for data from one or more clients. Such an architecture is particularly well suited for delivering content, such as web pages, audiovisual content, email messages, documents, and the like, across a network such as the Internet.

Servers respond to client requests for content by obtaining and/or generating the data to be transmitted. Some content is static in nature, and need only be retrieved from some repository. Other content is dynamic, involving some computation or processing before the content can be transmitted. In many cases, content to be delivered to a client includes a combination of static and dynamic components.

In order to improve efficiency and reduce network traffic, content is often cached either at a client or at a server. A cache is a temporary copy of data that generally provides more rapid or efficient access than does the original source of the data.

Content cached at a client can be retrieved from the cache when needed and thereby avoid a request to a server. However, a client-based cache presents a burden to the client, requiring storage space and relying on the client to perform cache management operations, and sometimes requiring specialized configuration of the client. A client-based cache may also present a security risk, as data stored on the client may be more easily accessed by unauthorized persons, particularly if a shared computer is used. Finally, a client-based cache may not always be available when it might be advantageous, for example if the user clears the cache between sessions or between visits to a web page. In addition, application servers have limited options for adjusting expiration policies for client-based caches or for repopulating client-based caches, because servers usually cannot initiate communication with clients.

Content cached at a server can be provided in response to a client request without performing inefficient requests from databases and without time-consuming dynamic content generation. However, server-based caching is of limited value as it does not reduce traffic between the client and the server. The client still must make requests from the server, and the server must still provide content in response to those requests. Server-based caching may speed up the process of obtaining or generating the content at the server end, but in other respects does not improve performance over non-cached content. When clusters of servers are used, often referred to as server farms, load balancing efficiency is reduced if requests must be routed only to servers that have cached the requested content, resulting in the need to cache data redundantly on multiple servers and to ensure that the multiple server caches are synchronized.

In addition, many conventional caching systems, whether server- or client-based, fail to provide partial caching in a robust manner. Such systems often require content to be retrieved from a primary source even when some portion of the content might be (theoretically or actually) cached. In other words, for content having some portion that is cacheable and relatively static, and another portion that is dynamic and/or unavailable at a cache, many existing systems fail to do any caching at all.

What is needed is a caching mechanism that avoids the limitations of conventional client-based and server-based caches. What is further needed is a caching mechanism that can provide the advantages of caching without unduly burdening a client or a server and without losing efficiency when additional servers are added. What is further needed is a caching mechanism that is able to perform partial content caching, wherein a portion of the content is cached and a portion is not.

### SUMMARY OF THE INVENTION

According to the present invention, a network device, referred to as an appliance is located in the data path between a user computer (client) and a server. The appliance has a high performance in-memory cache that is used to cache relatively static cacheable pages, documents, or other items of content. When a request is received at the appliance, the appliance can determine whether any portion of the requested data is available in its cache; if so, that portion can be serviced by the appliance. If any portion of the requested content is dynamic and cannot be serviced by the appliance cache, the dynamic portion is generated by the appliance or requested and received from one or more sources, such as application servers.

The appliance integrates the content retrieved from the cache, the dynamically generated content, and the content received from other sources to generate a response to the original content request. After post-processing, the original request is serviced.

The present invention thus implements partial content caching for content that has a cached portion and a portion to be dynamically generated. Thus, the invention extends the usefulness of the appliance cache and minimizes the amount of information that must be obtained from other sources. The invention thus reduces the amount of information that needs to be retrieved from web servers and/or application servers when the information is already available at the appliance.

In a network including a router and a number of application servers that respond to requests from clients, the appliance can be positioned between the router and the application servers. The appliance can be implemented as a single device or a set of devices acting in series or in parallel. Software runs on the application servers to facilitate communication with the appliance according to the techniques described herein. Requests coming through the router from client devices to the application servers and all responses sent from the application servers to fulfill client requests pass through the appliance. The router can also be configured to bypass the appliance for certain applications.

In one embodiment, the appliance consists of hardware and software. The software that runs on the appliance is a modular and extensible set of treatments, or plug-ins, that primarily operate on requests and responses passing through the appliance and that employ a common data store. The appliance and the software running on the application servers communicate with one another using application requests and responses. However, in some embodiments, the appliance and the software running on the application servers can optionally communicate with one another directly, asynchronously and independently of the flow of requests and responses, if such a communication path is available.

In one embodiment, the appliance is implemented in combination with a router in the data path between the user and the web server (and/or application server). The router performs the data storage, retrieval, and communication functions herein described in addition to the functions commonly performed by a router.

The appliance can be implemented as a single device or a set of devices acting in series or in parallel. Software runs on the application servers so as to communicate with the appliance.

The appliance thereby provides improved caching capability including partial caching. The appliance is able to intercept content requests addressed to servers, and to service such requests locally where feasible, either wholly or partially. Where content from a server is to be assembled with content retrieved from the appliance's cache, the appliance performs such assembly before relaying the requested content to the client.

Thus, the appliance of the present invention operates in a manner that is seamless and transparent to both the server and the client, and that provides several advantages over prior art schemes.

One skilled in the art will recognize that the invention can be implemented using other types of application servers and communication paradigms. The invention takes advantage of close integration with application server software both in the software that runs on the servers and also in the software that runs on the appliance.

### BRIEF DESCRIPTION OF THE DRAWINGS

FIG. 1(A) is a block diagram illustrating a combined appliance and router, connected in the data path of a typical wide area network connection, according to one embodiment of the present invention.

FIG. 1(B) is a block diagram illustrating an appliance connected in the data path of a typical wide area network connection, according to one embodiment of the present invention.

FIG. 1(C) is a block diagram illustrating a combined appliance and router, connected in the data path of a typical wide area network connection, according to one embodiment of the present invention.

FIG. 2 is a block diagram illustrating the hardware configuration of an appliance, according to one embodiment of the present invention.

FIG. 3 is a flowchart depicting a method of partial content caching according to one embodiment.

FIG. 4 is a flowchart depicting, in more detail, a method of partial content caching according to one embodiment.

FIG. 5 is a flowchart depicting, in more detail, the steps performed by the application server in the partial content caching method of the present invention.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

### Architecture

Embodiments of the present invention are now described with reference to the figures where like reference numbers indicate identical or functionally similar elements.

According to one embodiment of the present invention, the appliance is located in-line, i.e., within the data path between the user computer and the web server, so that the system of the present invention has the opportunity to intercept messages from the user computer to the web server and from the web server to the user computer.

For the purposes of illustration, the term “user computer” will be employed throughout this disclosure to refer to any electronic device capable of sending and receiving messages on a network. A non-exhaustive list of examples of user computers includes personal computers, enterprise computing systems, cell phones, handheld devices, personal digital assistants (PDAs), gaming consoles, and portable entertainment systems. One skilled in the art will recognize that any number of devices may be implemented to fulfill the role of the “user computer” described herein without departing from the scope of the present invention.

The appliance may use methods to associate content with a specific user, or it may use methods to associate content with a specific user computer. Some computer systems support multiple users on the same computer, and some users may use multiple computers. The invention is equally applicable to both user-specific content and user computer-specific content.

For the purposes of illustration, the invention is frequently described herein as being useful in conjunction with HTTP requests, HTTP responses, web servers, and/or application servers. However, it will be apparent to one skilled in the art that the invention is useful in conjunction with any kind of data request, any kind of data response, any kind of data server, and any form of data.

The appliance is described as a server for the purposes of illustrating one embodiment of the present invention. According to another embodiment of the present invention, the function of the appliance can be performed by any device capable of storing and retrieving a segment of data.

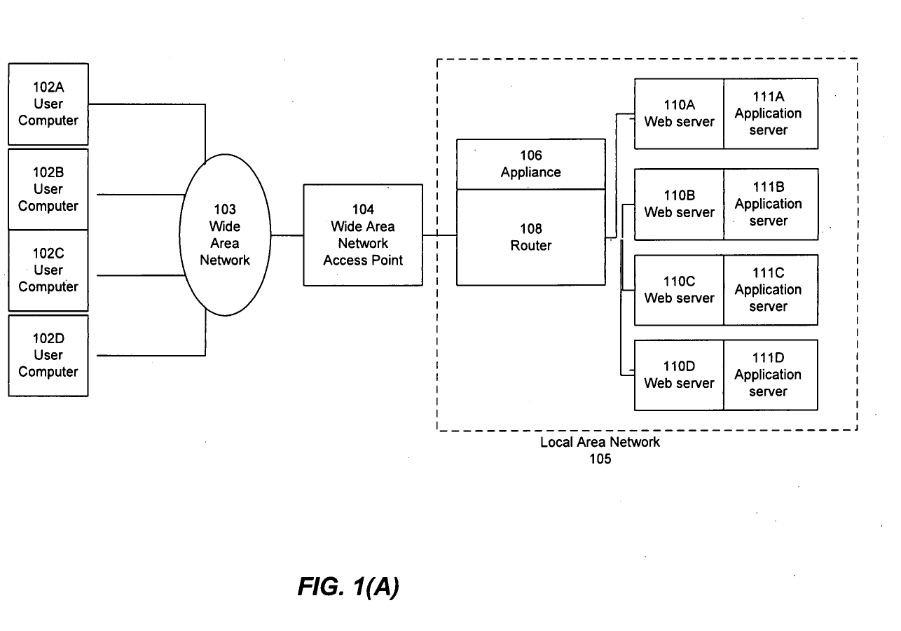

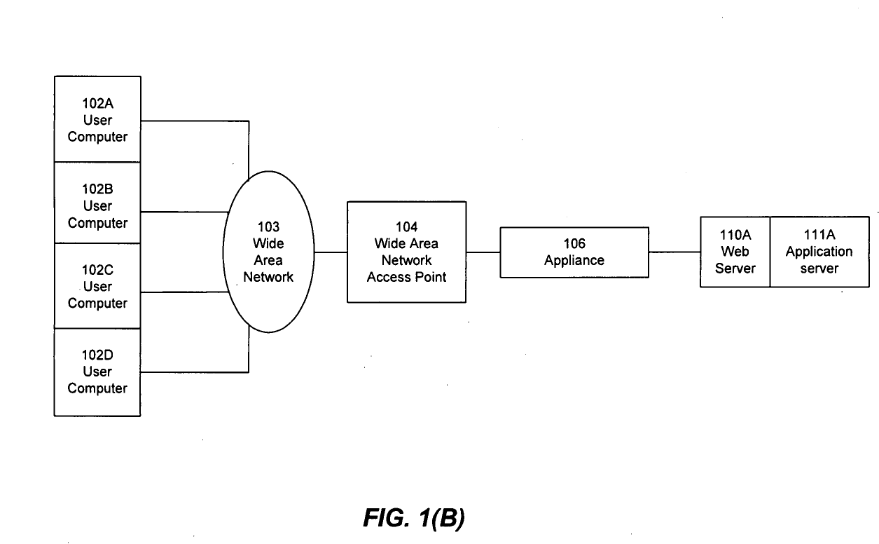

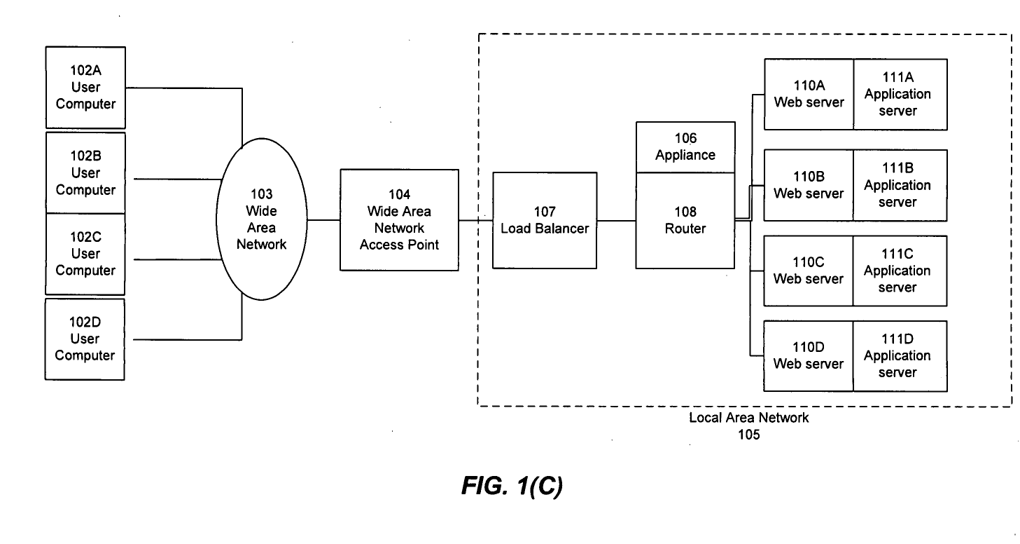

FIG. 1(A) is a block diagram illustrating a combined appliance 106 and router 108, connected in the data path of a typical wide area network 103 connection, according to one embodiment of the present invention. Each user computer 102 is a device capable of making requests for data over a wide area network. For example, each user computer 102 can be a personal computer executing a standard web browser program, or it can be a portable device requesting data using another protocol. In one embodiment, there are a plurality of user computers 102A, 102B, 102C, and 102D connected to a wide area network 103.

Each user computer 102 is capable of storing index data at the request of a server connected to the wide area network 103. Once stored, this index data is sent to the server as a component of future data requests, according to the techniques described herein. The index data may be stored on the user computer 102 and included in future data requests using a variety of methods. For example, according to one embodiment of the present invention, HTTP cookies may be used to store index data on the user computer 102. According to another embodiment of the present invention, HTTP-post hidden form fields, ASP.NET View State fields, HTTP headers, and URL query strings may be used to store index data on the user computer 102.

Each user computer 102 may be connected to the wide area network 103 through at least one of several connection devices, including routers, modems, and wireless access points. These connection devices and methods are well known in the art and are not shown in FIG. 1(A).

The wide area network 103 may be any network capable of connecting a user computer 102 with a web server 110 and/or application server 111. In one embodiment, the wide area network 103 is the Internet. In another embodiment the wide area network 103 is a private network. The wide area network 103 is capable of conveying messages bi-directionally between the user computer 102 and the wide area network access point 104.

The wide area network access point 104 is the point of connection between the wide area network 103 and the local area network 105. The wide area network access point 104 may be a digital subscriber line modem, an analog modem, a cable modem, a network card, a broadband wireless hub, or any other device for transferring data between the wide area network 103 and the local area network 105.

For clarity, the appliance 106, the router 108, the web server 110, and the application server 111 are depicted as components of a local area network 105. However, in one embodiment, the router 108 can in fact be a great distance from the web server 110 and/or application server 111, and can further be considered as part of a separate network. The presentation of the appliance 106, the router 108, the web server 110, and/or the application server 111 as components of the local area network 105 is intended to clarify the description of the invention for the purposes of enablement and is not intended to limit the forms the invention can take.

In one embodiment, the local area network 105 interfaces with a single wide area network access point 104 and includes at least one web server 110 and/or application server 111. Connected between the wide area network access point 104 and the web server 110 and/or application server 111 is at least one router 108. The router or routers 108 is/are configured to efficiently relay data among the web servers 110 and/or application servers 111 (if multiple web servers 110 and/or application servers 111 are implemented) and between a web server 110 and/or application server 111 and the wide area network access point 104. Other network devices may also be connected to the local area network 105.

In FIG. 1(A), a single router 108 is depicted, with an appliance 106 adjoined. The router 108 is capable of receiving an incoming message and repeating it on at least one of a plurality of network ports. The router 108 may also modify the incoming message before repeating it, such as in the well-known method of network address translation (NAT).

The appliance 106 may be adjoined to the router 108 differently depending on the embodiment of the invention. In one embodiment, the appliance operates using the same physical hardware (such as processor, network ports, electronic storage) as the router 108. In another embodiment, the appliance 106 shares some physical hardware (such as enclosure, power supply, and network ports) but does not share certain other physical hardware (such as processor and electronic storage). In another embodiment, the appliance 106 does not share any physical hardware with the router 108, but the appliance 106 is connected in series to at least one router 108.

In an implementation with multiple routers 108, the appliance 106 can be joined to any one of the routers 108 so long as the placement sets the appliance 106 in the data path between a web server 110 and/or application server 111 and the wide area network access point 104. According to one embodiment of the present invention, multiple appliances are implemented, and are connected either in series or parallel in the data path between a web server (and/or application server) and a wide area network access point. In a preferred embodiment, when multiple routers 108 are implemented hierarchically, the appliance 106 adjoins the router 108 with the highest position in the hierarchy of those routers 108 connected to web servers 110 and/or application servers 111.

The appliance 106 is connected in such a way so that it may intercept messages originating from each user computer 102 and destined for the web server 110 and messages originating from the web server 110 and/or application server 111 and destined for each user computer 102. In some embodiments, a router can be configured to bypass the appliance for certain applications.

In one embodiment, the appliance 106 is implemented using the Microsoft web server application suite ASP.NET. ASP.NET application server software may be implemented in several forms, including the following:
ASP.NET providers (http://msdn2.microsoft.com/en-us/library/aa479030.aspx)
ASP.NET controls (http://msdn2.microsoft.com/en-us/library/zt27tfhy.aspx)
ASP.NET control adapters (http://msdn.microsoft.com/msdnmag/issues/06/10/ExtremeASPNET/)
ASP.NET data providers (http://msdn.microsoft.com/msdnmag/issues/01/12/DataProv/)
IIS ISAPI extension (http://msdn2.microsoft.com/en-us/library/ms525172.aspx)
ASP.NET HTTP modules and handlers (http://support.microsoft.com/kb/307985).

The method of the appliance 106 will be described in greater detail below.

Each web server 110 is connected to the router 108. Each web server 110 is a device capable of receiving a request for data and transmitting data in response, and for communicating with a back-end application server 111. For example, the web server 110 may be an HTTP server capable of receiving page requests and returning web pages according to the HTTP. As another example, the web sever 110 may be any server capable of sending datagrams according to a protocol such as the User Datagram Protocol (UDP), or the Transmission Control Protocol (TCP). The web server 110 may consist of multiple devices, which in conjunction have the capabilities of a web server 110. Although the example of a web server has been chosen for the purposes illustration, one skilled in the art will recognize that the invention is applicable to embodiments employing any device capable of receiving and transmitting data.

The web server 110 and/or application server 111 may be implemented using at least one of the many devices commonly available for responding to data requests. For example, the web server 110 and/or application server 111 may be implemented using a standard Personal Computer (PC) and software such as Apache HTTP Server. The web server 110 could also be implemented, for example, using Microsoft® Internet Information Services, ASP.NET, Classic ASP, JSP, IBM® Websphere, Ruby on Rails, or Linux Apache PHP. The web server could be implemented as an online gaming server. One skilled in the art will recognize that these examples are not intended to be exhaustive and that other implementations of the web server and/or application server are also applicable to the present invention.

The web server 110 and/or application server 111 may also include methods and/or systems for interfacing with the appliance 106. The method used by the web server 110 and/or application server 111, according to one embodiment of the present invention, is illustrated in FIG. 6.

FIG. 1(B) is a block diagram illustrating an appliance connected in the data path of a typical wide area network connection, according to one embodiment of the present invention. The appliance 106 is connected to the wide area network access point 104 and the web server 110 and/or application server 111. The appliance 106 may or may not be adjoined to a router 108.

The user computer 102, wide area network 103, wide area network access point 104, web server 110 and/or application server 111 are similar to those herein described in reference to FIG. 1(A). The appliance 106 is connected in such a way so that it may intercept messages originating from each user computer 102 and destined for the web server 110 and/or application server 111 and messages originating from the web server 110 and/or application server 111 and destined for each user computer 102. The method of the appliance 106 will be described in greater detail below. According to one embodiment of the present invention, the appliance 106 operates without a router and in conjunction with a single web server 110 and/or application server 111.

In one embodiment, the appliance 106 is implemented as a transparent proxy. As described in more detail below, the appliance 106 transparently removes, holds, tokenizes and re-inserts application data, instructions, and/or rule sets, such as ViewState data in ASP.NET pages. In this manner, the appliance 106 reduces bandwidth consumption and transfer time by tokenizing the ViewState received from the server and sending only the ViewState tokens to the client browser. A further advantage of the appliance 106 of the present invention is that it enables developers to use third party controls, regardless of ViewState size, reducing the need to trade off application features to achieve application responsiveness.

In other embodiments, the appliance 106 is able to perform additional functionality, such as for example:
insertion of headers to control browser caching (a global time-based browser cache expiry policy);
dynamic compression (a web-acceleration technique);
insertion of JavaScript for analytics; and
SSL encryption.

FIG. 1(C) is a block diagram illustrating a combined appliance 106 and router 108, connected in the data path of a typical wide area network connection, according to one embodiment of the present invention. The user computer 102, wide area network 103, wide area network access point 104, appliance 106, router 108, web server 110, and/or application server 111 are similar to those herein described in reference to FIG. 1(A).

According to one embodiment of the present invention, the load balancer 107 is connected to the wide area network access point 104 and to the router 108. The load balancer 107 is capable of receiving an incoming page request and redirecting it to a web server 110 and/or application server 111 on the basis of the current availability of the various web servers 110 and/or application servers 111. For example, if web server 110A is overloaded due to a high volume of page requests, but web server 110B has available request-handling capability, the load balancer 107 directs incoming page requests to web server 110B. The load balancer 107 may be implemented using any one of many commonly available load balancing methods. Such methods can include random allocation, round-robin allocation, weighted round-robin, least connections, and IP hash among others.

In FIG. 1(C), a single router 108 is depicted, with an appliance 106 adjoined. As described herein with reference to FIG. 1(A), the appliance 106 may be adjoined to the router 108 differently depending on the embodiment of the invention. According to one embodiment of the present invention, the appliance 106 does not share any physical hardware with the router 108. The load balancer 107, router 108, and appliance 106 are connected in series, and may be connected in any order, according to one embodiment of the present invention. For example, the load balancer 107 may be connected between the wide area network access point 104 and the appliance 106, or the load balancer 107 may be connected between the appliance 106 and the web server 110. Other methods for connecting the wide area network access point 104, load balancer 107, router 108, and the appliance 106 without departing from the scope of the present invention will be apparent to one of skill in the art. According to one embodiment of the present invention, the appliance 106 may operate in conjunction with a load balancing device, such as the load balancer 107. According to another embodiment of the present invention, the load balancer 107 is adjoined to the appliance 106. The load balancer 107 and the appliance 106 may share all, some, or no physical hardware, according to various embodiments of the present invention.

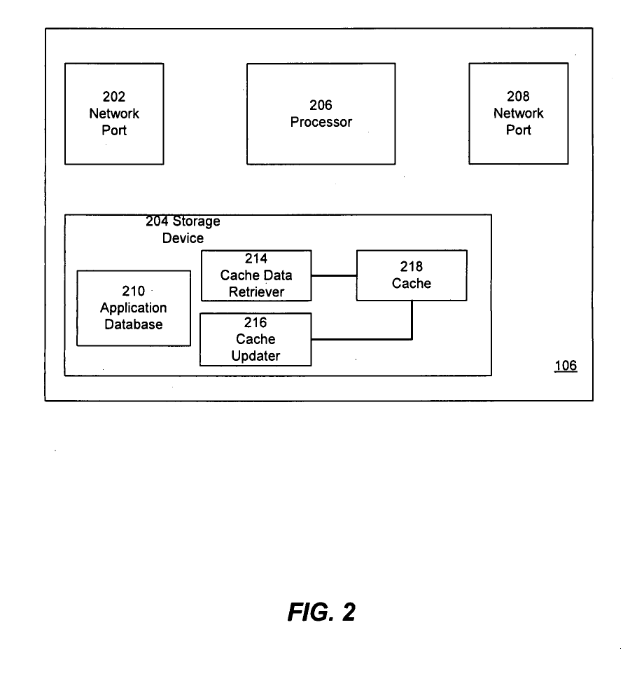

FIG. 2 is a block diagram illustrating the hardware configuration of one embodiment of the appliance 106, according to one embodiment of the present invention. As explained previously, some or all of the hardware of the appliance 106 may be shared with the router 108. FIG. 2 illustrates the hardware of the appliance 106 as if said hardware were dedicated, but in fact, some or all of this hardware can be shared with other devices.

The network ports 202 and 208 are standard devices capable of sending and receiving messages over a network. As a pair, the network ports 202 and 208 allow the appliance 106 to be in the data path between the wide area network access point 104 and the web server 110 and/or application server 111. Network messages not requiring caching or cache retrieval can be passed from one network device to the other without change, so that the normal operation of the network is not affected. On the other hand, network messages requiring either caching or cache retrieval can be read and/or modified as necessary before continuing on the data path to their destination. In addition, the appliance 106 can terminate network messages by responding to them, and it can originate new request messages.

The processor 206 is a standard processor capable of executing instructions. Any standard microcomputer processor could be used to implement the processor 206, for example, the x86 family of 32- and 64-bit processors.

The storage device 204 includes at least one of the many common components available for electronic storage. The storage device 204 stores incoming and outbound network messages and instructions for the processor 206. The storage device 204 also includes the application database 210. The application database 210 may be a standard database capable of storing and retrieving data on the basis of some index data.

Cache 218 represents a storage area for temporary storage of content, as described in more detail below. In one embodiment, storage device 204 also includes cache data retriever 214 and a cache updater 216. Cache data retriever 214 reads data from cache 218, and cache updater 216 writes data to cache 218.

### Summary of Operation

The appliance 106 can be used to implement automated output caching (also referred to as response caching), wherein static and near-static cacheable pages, documents, or other items of content are cached in a high performance in-memory cache 218 on the appliance 106. Items of content (or portions of those items of content) are stored at the appliance 106 with an expiration policy that is enforced on the appliance 106. When a request is received at the appliance 106, the appliance 106 can determine whether the requested data is available in its cache 218; if so, the request can be serviced by the appliance 106 without contacting the web server 110 and/or application server 111. This avoids the need to retrieve information from the web server 110 and/or application server 111 when the information is already available at the appliance 106.

In some instances, it is useful to cache part of the content in a web page, document, web service response, or other item of content, while maintaining the ability to dynamically generate another part of the content. The cached portions are then integrated with dynamically generated portions when requests are handled. This technique, referred to herein as partial content caching, or PCC, allows server resources to be used efficiently to generate only those sections of responses that require dynamic generation, thus improving the performance and efficiency of the system.

In one embodiment, the present invention can be used to implement a technique for partial web page caching. Instructions generated by a web application on the application servers are used to embed caching instructions in responses. These caching instructions indicate which sections of the page can be cached for future requests and which sections need to be generated dynamically by an application server in response to future requests. This improves the effectiveness of a response cache architecture by enlarging the scope of pages that can be cached. Specifically, web pages that have both static and dynamic portions can be cached, at least in part. Furthermore, partial page caching reduces the processing required for rendering of dynamic pages on application servers by allowing only the dynamic portions of mostly static pages to be rendered by the application server.

The appliance 106 reads and executes the caching instructions in the responses, caches them with the content, and passes the response to the client computer 102. The appliance 106 detects when content retrieved from the output cache 218 contains sections to be dynamically generated and requests the content for just those sections. The appliance 106 embeds dynamically generated sections within the cached response to create the final response to the client computer 102.

In one embodiment, the appliance 106 of the present invention uses bi-directional embedding of information (i.e. from the application server 111 to the appliance 106, and vice versa) to implement partial content caching.

The partial content caching technique of the present invention thus provides a mechanism for performing such cache operations at a central appliance 106 rather than at individual servers. This improves performance and reduces network traffic, by avoiding the need for servers 110 and/or 111 to service requests that can be handled by the appliance 106. In addition, by integrating cached portions serviced by appliance 106 with dynamic portions serviced by servers 110 and/or 111, the present invention reduces the amount of content that needs to be served by a server 110 and/or 111.

### Method

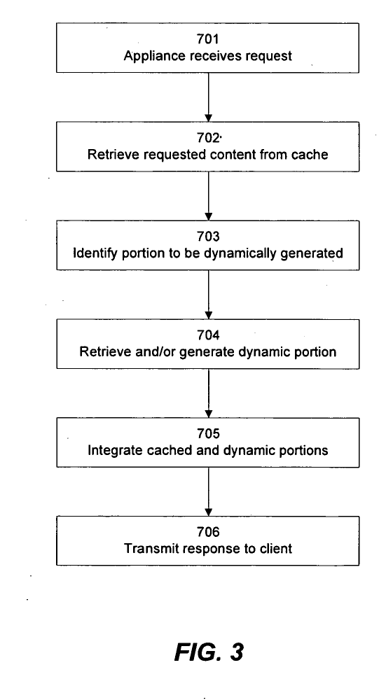

Referring now to FIG. 3, there is shown a flowchart depicting a method of partial content caching according to one embodiment. The appliance 106 receives 701 a request, recognizes that the requested content is available in its cache 218, and retrieves 702 the content from the cache 218. The retrieved information includes some indication that a portion of the content needs to be generated dynamically; for example, a portion may require a recent sports score, weather item, or news item. The appliance 106 identifies 703 the portion to be dynamically generated. In one embodiment, a cached content item includes an HTTP header that indicates to the appliance 106 what portions of the content should be dynamically generated. In another embodiment, the dynamic content is indicated by special segments of HTML.

The appliance 106 then retrieves (for example from an application server 111) and/or generates 704 the dynamic portion. In one embodiment, the dynamic portion can be directly obtained from the incoming request and incorporated by substitution into the static cached portion. In another embodiment, the dynamic portion is retrieved via an external call to a server (such as application server 111), wherein the appliance 106 passes a portion of the original request, possibly combined with a portion of the statically cached content; the result is received and integrated into the statically cached portion.

Once all dynamic portions have been integrated 705 into the portion retrieved from the cache 218, the result is transmitted 706 to the client.

The partial content caching methodology of the present invention provides several advantages over prior art schemes. By handling the substitution at the appliance 106, the present invention avoids unduly burdening individual application servers and avoids the need to duplicate and/or synchronize cached information among the application servers 111. In addition, any information available in the request can be passed to the server 111 by the appliance 106, providing access to information that might not otherwise be available. In one embodiment, by passing a portion of the original HTTP request through to the application server 111, the present invention can provide access to cookies or HTTP headers; for example, a cookie or HTTP header containing a session ID value.

In one embodiment, the application developer specifies particular web pages or portions thereof that should be cached. For example, a developer can add an ASP.NET control that indicates that a particular portion of a page should be dynamically generated.

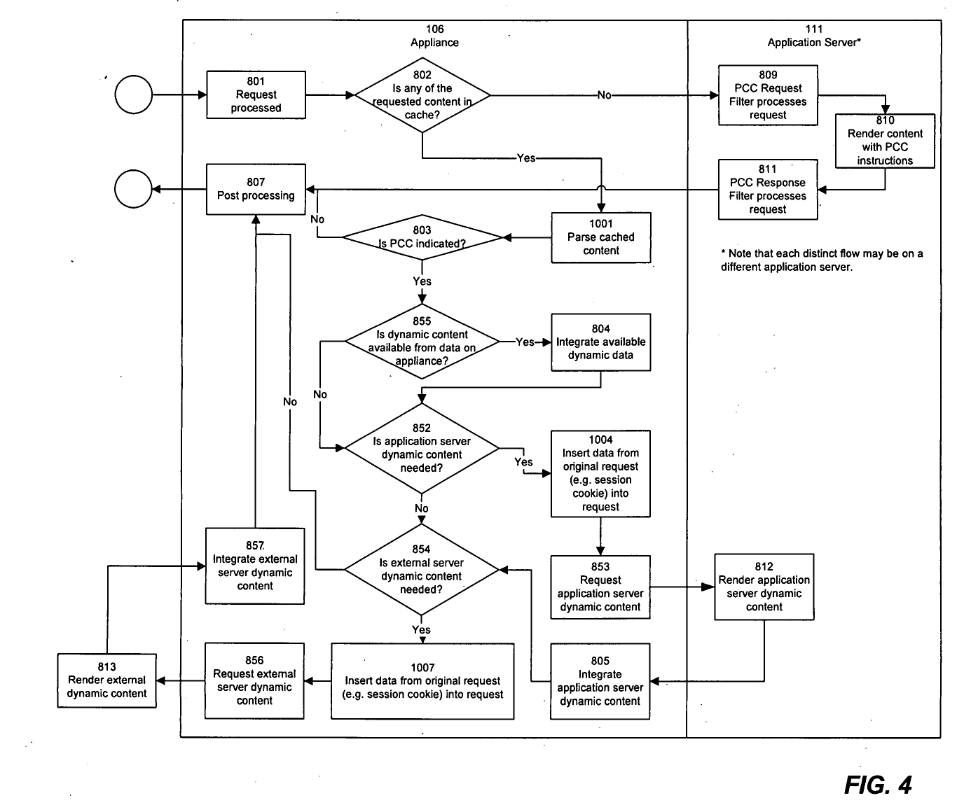

Referring now to FIG. 4, there is shown a flowchart depicting, in more detail, a method of partial content caching according to one embodiment.

The appliance 106 receives a request for a page, document, or other content item from a client, and processes 801 the request to determine whether it can be handled locally at the appliance 106.

The appliance 106 determines 802 whether any of the data for the requested content item is available in the appliance's 106 cache 218. If none of the data is in the cache 218, the request is passed along to the application server 111 (and/or the web server 110). In this case, the request to the application server 111 is for the entire content item. The content request is first processed 809 by software running on the application server 111, referred to herein as the Partial Cache Content (PCC) Request Filter. In this embodiment, the PCC Request Filter examines the HTTP headers of the incoming traffic in order to determine whether or not the request is for an entire page, document, or other content item, or for one or more dynamic portions to be integrated with cached content.

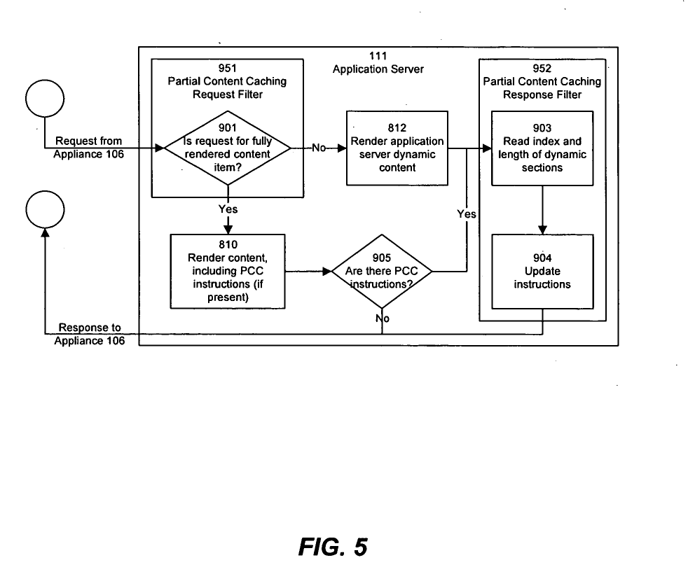

The software running at the application server 111 renders 810 the content, adding partial content caching instructions. These instructions are parsed 811 by software running on the application server 111, referred to herein as the PCC Response Filter. The PCC Response Filter reads the instructions in the rendered content in order to generate an HTTP header to be consumed by the appliance 106, as further described below in connection with FIG. 5. In one embodiment, ASP.NET controls generate the instructions as HTML comment code encapsulating the dynamic section. In another embodiment, other actions of the content rendering process generate the instructions as HTML comment code, again encapsulating the dynamic section.

In one embodiment, these embedded instructions in HTML comment code are processed 811 by the PCC Response Filter. The PCC Response Filter removes the hidden instructions and generates an HTTP header. This HTTP header is later used by the appliance 106 when storing content in its cache 218 and determining which portions of the stored content should be dynamically generated. In one embodiment, the HTTP header includes index and length information to identify which segments of the rendered content are dynamic. This improves the efficiency of the appliance's 106 efforts in combining cached content with dynamically generated content.

Once the PCC Response Filter has processed the request, the application server 111 sends the requested content to the appliance 106.

In one embodiment, when the appliance 106 receives a content item from the application server 111 with an HTTP header indicating partial content caching, the appliance 106 ignores the dynamic sections of content when building a hash for tracking the cached item. In this manner, caching is performed effectively, taking into account the fact that the dynamic sections are not appropriate for caching. After a content item has been added to the cache 218 and when the appliance 106 is serving it, the appliance 106 will replace the dynamic sections in the static cached content with dynamic content. As described below, all data required to render a response that is available from the request to the appliance 106, such as data contained in cookies or data that can be retrieved using index data contained in cookies, will be integrated with cached data inside the appliance. Similarly, all needs for dynamic data not available from the request to the appliance 106 will be packaged into as few requests as possible to the appropriate server or servers to obtain the required data to be integrated into the cached content by the appliance 106.

The appliance then performs any post-processing 807, including any other treatments that the appliance 106 must apply. The appliance 106 then delivers the content to the client.

If, in step 802, at least some of the data for the requested content is in the cache 218, the appliance 106 parses 1001 the content in order to determine 803 whether any partial content caching is indicated, signifying that some of the cached content should be replaced by dynamic content. In one embodiment, a need for partial content caching is indicated by the presence of the aforementioned HTTP header within the cached data. If no partial content caching is indicated, the appliance 106 applies any necessary post-processing 807 such as other data treatments. The appliance 106 then delivers the content to the client.

If, in step 803, partial content caching is indicated, the appliance 106 determines 855 whether any of the dynamic content needed for the substitution is available from data already on the appliance 106 or already in the request from the client. In one embodiment, a developer can specify where such dynamic content comes from. For example, in some embodiments the dynamic content may be generated with reference to a cookie or web service that does not require any content to be requested from the application server 111. In such an embodiment, a cookie found in the content request may be all that is needed to generate or obtain the dynamic content. If at least some of the dynamic content is available without requesting it from the application server 111, the appliance 106 retrieves the dynamic content and integrates 804 the retrieved dynamic content into the cached content.

The appliance 106 then determines 852 whether any dynamic content from the application server 111 is needed, for example if the content is not available at the appliance 106. If so, the appliance 106 inserts 1004 any appropriate data from the original request, such as cookies or other HTTP headers, or URL query string parameter values, into a request 853 for the needed dynamic content from the application server 111. In this case, the request is only for the dynamic portions of the content that must be provided by the application server, and not the fully rendered content. Upon receiving the request, the application server 111 renders 812 the requested dynamic content and returns it to the appliance 106. The appliance then integrates 805 the dynamic content with the cached content and with any other content generated at the appliance.

The appliance 106 then determines 854 whether any dynamic content is required from a server external to the appliance 106 and its associated application servers 111 (or web servers 110), for example if the content is not available at the appliance 106 or the application server 111. If so, the appliance 106 inserts 1007 any appropriate data from the original request, such as cookies or HTTP headers into a request 856 for the needed dynamic content from the external server. In this case, the request is only for the dynamic portions of the content that must be provided by the external server, and not the fully rendered content. Upon receiving the request, the external server renders 813 the requested dynamic content and returns it to the appliance 106. The appliance 106 then integrates 857 the dynamic content with the content already at the appliance 106. In one embodiment, the appliance 106 generates a collection of web service calls with information taken from the HTTP request's cookies in order to generate the dynamic output.

The appliance 106 then performs post processing 807 and delivers the content to the client.

In one embodiment, the appliance 106 collects all dynamic sections in the cached content that need data from the application server and generates a single HTTP request to the application server 111. This causes all dynamic content to be rendered at the application server 111; then the appropriate section indices and length values are updated to reflect the final, rendered data by the PCC Response Filter. The appliance 106 then parses the response generated by the application server 111 and replaces the dynamic sections of the content with the rendered data, as described in more detail below.

### Operation of Application Server

Referring now to FIG. 5, there is shown a flowchart depicting, in more detail, the steps performed by the application server 111 in the partial content caching method of the present invention. A request is received from appliance 106. The PCC request filter 951 of the application server 111 determines 901 whether the request is for a fully rendered content item, and not just the dynamic portion of a content item. If the request is for a fully rendered content item, the application server 111 renders 810 the content. Additional data, referred to as PCC instructions, may be added to the content in order to identify where the appliance 106 should later substitute or add dynamic content in response to subsequent requests. In one embodiment, this data is added into the HTML by ASP.NET controls. In another embodiment, this data is added directly into the response during rendering of the content. In effect, the PCC instructions provide a mechanism for turning a part of a rendered content item into a request for dynamic content, to be used in response to subsequent requests after the initial response is cached at the appliance 106.

If instructions are present 905 in the content after rendering, the PCC Response Filter 952 reads 903 the index and length of the dynamic sections. For each section of dynamic data, the PCC Response Filter 952 generates or updates 904 an HTTP header in the HTTP response.

If, in step 901, the request is for the dynamic data only, then only those portions of the content are rendered. Requested data is rendered 812 into a single response, with each section of dynamic data segmented with parsing instructions. In one embodiment, the PCC Response Filter 952 then processes the instructions to read 903 the index and length of the dynamic sections, and then generates or updates 904 an HTTP header in the HTTP response.

The final result is returned as a response to the appliance 106.

### HTTP Header Format

In one embodiment, an HTTP header indicating partial content caching is included whenever appropriate. If the header is not present, no special handling of the content is needed.

In one embodiment, the header is formatted as follows:
X-Strange-PCC:

| | |
|---|---|
| response-value = | list-size ” \| ” resp-section-list |
| list-size = | length |
| resp-range-list = | *( resp-range ” \| ” ) |
| resp-range = | type ”,” index ”,” length ”,” source |
| type = | cookie-type \| callback-type |
| cookie-type = | ”A” |
| callback-type = | ”B” |
| index = | 0 \| positive-int |
| length = | positive-int |

The list-size value specifies the number of resp-range elements in the resp-range-list. If a section is of cookie-type, the source is the name of the cookie from which the proxy needs to extract the value. If a range is of the callback-type, the source is a signature string used to invoke the callback method. In one embodiment, the cookie name or the method signature string must not contain characters that can cause parsing error, in particular “|”, CR (carriage return), LF (line feed).

An example of a header according to the above format is:
X-Strange-PCC: 3|A,5,20,name|B,70,5,signature1|B,100,15,signature2|

In this example, there are three dynamic sections: One to be replaced with the value of a cookie named “name” from index 5 for 20 characters, one to be replaced with the output of a callback named “signatures” from index 70 for 5 characters, and one to be replaced with the output of a callback named “signature2” from index 100 for 15 characters.

One skilled in the art will recognize that this header format is merely exemplary, and that any other layout or format can be used.

### Treated HTML Document

In addition to the HTTP header added to the top of the document in one embodiment, any dynamic section of HTML code can be encapsulated by HTML comments to note the beginning and the end of the section. These comments can be used, for example, to allow the PCC Response Filter to identify the start and end of a section when generating the index values to be later used in the HTTP header.

Before each dynamic section, an HTML comment is placed, for example formatted as follows:
<!—SL-PCS CO,“Name”—>

The “SL-PCS” represents the beginning of the comment, and then the two-letter mode code is displayed followed by a comma and the MethodName in quotes. In the example above, the dynamic code is a cookie value with the key “Name”. A “closing” HTML comment appears at the end of the content, for example:
<!—/SL-PCS—>

If an ASP.NET control references a cookie with a key called “Name” and a value of “Steve”, then the resulting HTML would be:
<!—SL-PCS CO,“Name”—>Steve<!—/SL-PCS—>

In one embodiment, HTML comments are used instead of HTTP headers to contain all the data required by the appliance.

One skilled in the art will recognize that the invention can be implemented using other types of indications instead of HTTP headers or HTML comments. For example, in HTML documents, hidden form fields, JavaScript variables JavaScript functions, or other elements could be used to encode these indications.

In one embodiment, these indications of which sections of a message should be replaced with dynamically generated content when retrieved from a cache are sent from a server to a caching appliance in separate asynchronous messages rather than in the body or headers of the messages containing the content. In one embodiment, the invention uses a mechanism as described in related U.S. patent application Ser. No. 11/623,028 for “Asynchronous Context Data Messaging,” (Atty. Docket No. STR12123), filed Jan. 12, 2007, the disclosure of which is incorporated herein by reference.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention can be embodied in software, firmware or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

While the invention has been particularly shown and described with reference to a preferred embodiment and several alternate embodiments, it will be understood by persons skilled in the relevant art that various changes in form and details can be made therein without departing from the spirit and scope of the invention.

What is claimed is:

1. In a network device situated in a communication path between a client and an application server, a method for caching content, comprising:
receiving a content request from the client; and
responsive to at least a portion of the requested content being available in a cache:
retrieving the available content from the cache;
identifying a portion of the content to be generated dynamically;
obtaining dynamically generated content for the identified portion;
integrating the retrieved content from the cache and the dynamically generated content; and
transmitting the integrated content to the client.

2. The method of claim 1, wherein identifying a portion of the content to be generated dynamically comprises parsing the content retrieved from the cache.

3. The method of claim 1, wherein identifying a portion of the content to be generated dynamically comprises reading a header associated with the content retrieved from the cache.

4. The method of claim 1, wherein identifying a portion of the content to be generated dynamically comprises reading at least one selected from the group consisting of:
at least one hidden form field;
a comment;
a script;
a variable; and
a function.

5. The method of claim 1, wherein identifying a portion of the content to be generated dynamically comprises receiving an indication asynchronously with respect to the content.

6. The method of claim 1, wherein obtaining dynamically generated content comprises:
transmitting, to a server, a request for the dynamically generated content; and
receiving the requested dynamically generated content from the server.

7. The method of claim 6, further comprising:
reading information from the content request;
wherein transmitting the request for the dynamically generated content comprises transmitting a request comprising the read information from the content request.

8. The method of claim 6, wherein the server comprises an application server.

9. The method of claim 6, wherein the server comprises an external server.

10. The method of claim 1, wherein obtaining dynamically generated content comprises generating the dynamically generated content at the network device.

11. The method of claim 10, wherein generating the dynamically generated content comprises:
reading information from the content request; and
generating the dynamically generated content at least partially based on the read information from the content request.

12. The method of claim 1, wherein the content request comprises an HTTP request.

13. The method of claim 1, wherein the client is located remotely with respect to the network device.

14. The method of claim 1, further comprising, responsive to no portion of the requested content being available in a cache:
requesting the content from a server;
receiving the requested content from the server; and
transmitting the requested content to the client.

15. In an application server adapted to receive content requests from a network device situated in a communication path between a client and the application server, a method for providing partial content caching instructions, comprising:
receiving a content request from the network device;
obtaining content for the request;
generating an indication identifying at least a portion of the obtained content as being dynamic; and
transmitting the obtained content and the generated indication to the network device.

16. The method of claim 15, further comprising, prior to transmitting the obtained content and the generated indication, integrating the generated indication with the obtained content.

17. The method of claim 15, further comprising, prior to transmitting the obtained content and the generated indication, integrating the generated indication with the obtained content.

18. The method of claim 15, wherein the indication comprises a header.

19. The method of claim 15, wherein the indication comprises at least one selected from the group consisting of:
at least one hidden form field;
a comment;
a script;
a variable; and
a function.

20. The method of claim 15, wherein transmitting the generated indication comprises transmitting the generated indication asynchronously with respect to transmitting the obtained content.

21. A system for caching content, comprising:
an application server, for receiving and responding to content requests;
a network device situated in a communication path between a client and the application server, for receiving content requests from the client;
a cache, communicatively coupled to the network device, for storing content;
wherein, responsive to receiving a content request from a client wherein at least a portion of the requested content is available in the cache, the network device:
retrieves the available content from the cache;
identifies a portion of the content to be generated dynamically;
obtains, from the application server, dynamically generated content for the identified portion;
integrates the retrieved content from the cache and the dynamically generated content; and
transmits the integrated content to the client.

22. The system of claim 21, wherein the network device identifies a portion of the content to be generated dynamically by parsing the content retrieved from the cache.

23. The system of claim 21, wherein the network device identifies a portion of the content to be generated dynamically by reading a header associated with the content retrieved from the cache.

24. The system of claim 21, wherein the network device identifies a portion of the content to be generated dynamically by reading at least one selected from the group consisting of:
at least one hidden form field;
a comment;
a script;
a variable; and
a function.

25. The system of claim 21, wherein the network device identifies a portion of the content to be generated dynamically by receiving an indication asynchronously with respect to the content.

26. The system of claim 21, wherein the network device obtains dynamically generated content by requesting content from the application server and receiving the requested content from the application server.

27. The system of claim 21, wherein the network device obtains dynamically generated content by generating the dynamically generated content at the network device.

28. The system of claim 21, wherein, responsive to no portion of the requested content being available in the cache, the network device:
requests the content from the application server;
receives the requested content from the application server; and
transmits the requested content to the client.

29. The system of claim 21, wherein, responsive receiving a content request from the network device, the application server:
obtains content for the request;
generates a header identifying at least a portion of the obtained content as being dynamic; and
transmits the obtained content and the generated header to the network device.

30. A computer program product for caching content in a network device situated in a communication path between a client and an application server, the computer program product comprising:
a computer-readable storage medium; and
computer program code, encoded on the medium, for:
receiving a content request from the client; and
responsive to at least a portion of the requested content being available in a cache:
retrieving the available content from the cache;
identifying a portion of the content to be generated dynamically;
obtaining dynamically generated content for the identified portion;
integrating the retrieved content from the cache and the dynamically generated content; and
transmitting the integrated content to the client.

31. The computer program product of claim 30, wherein the computer program code for identifying a portion of the content to be generated dynamically comprises computer program code for parsing the content retrieved from the cache.

32. The computer program product of claim 30, wherein the computer program code for identifying a portion of the content to be generated dynamically comprises computer program code for reading a header associated with the content retrieved from the cache.

33. The computer program product of claim 30, wherein the computer program code for identifying a portion of the content to be generated dynamically comprises computer program code for reading at least one selected from the group consisting of:
at least one hidden form field;
a comment;
a script;
a variable; and
a function.

34. The computer program product of claim 30, wherein the computer program code for identifying a portion of the content to be generated dynamically comprises computer program code for receiving an indication asynchronously with respect to the content.

35. The computer program product of claim 30, wherein the computer program code for obtaining dynamically generated content comprises computer program code for:
transmitting, to a server, a request for the dynamically generated content; and
receiving the requested dynamically generated content from the server.

36. The computer program product of claim 30, wherein the computer program code for obtaining dynamically generated content comprises computer program code for generating the dynamically generated content at the network device.

37. The computer program product of claim 30, further comprising computer program code for, responsive to no portion of the requested content being available in a cache:
requesting the content from a server;
receiving the requested content from the server; and
transmitting the requested content to the client.

38. A computer program product for providing partial content caching instructions in an application server adapted to receive content requests from a network device situated in a communication path between a client and the application server, comprising:
a computer-readable storage medium; and
computer program code, encoded on the medium, for:
receiving a content request from the network device;
obtaining content for the request;
generating an indication identifying at least a portion of the obtained content as being dynamic; and
transmitting the obtained content and the generated indication to the network device.

39. The computer program product of claim 38, wherein the indication comprises a header.

40. The computer program product of claim 38, wherein the indication comprises at least one selected from the group consisting of:
at least one hidden form field;
a comment;
a script;
a variable; and
a function.

41. The computer program product of claim 38, wherein the computer program code for transmitting the generated indication comprises computer program code for transmitting the generated indication asynchronously with respect to transmitting the obtained content.
